(19) United States
(12) Patent Application Publication
(10) Pub. No.: US 2006/0168855 A1
(43) Pub. Date: Aug. 3, 2006

(54) Multi-fuctional display panel combining interlocking couplings

(76) Inventor: Sean D'Urban Jackson, London (GB)

Correspondence Address: PETERS VERNY JONES & SCHMITT, L.L.P., 425 SHERMAN AVENUE, SUITE 230, PALO ALTO, CA, 94306, US

(21) Appl. No.: 10/542,224

(22) PCT Filed: Jan. 13, 2004
(86) PCT No.: PCT/GB04/00113

§ 371 Date: Jul. 14, 2005

(30) Foreign Application Priority Data
Jan. 15, 2003 (GB) 0300918.0

(51) Int. Cl. G09F 7/00

(52) U.S. Cl. 40/584

(57) ABSTRACT

A display panel (10) comprises a generally rectangular panel having a male part (11) of a releasable hinge connection disposed along one edge thereof, and a counterpart female part (20) of a hinge connection disposed along an opposite edge thereof. Several such panels may be inter-engaged together along the edges and, via a connector device, along their ends to provide a versatile display system.

The present invention relates to a display panel, to a connector and to a display system.

Display system units for leaflets, notices, cards and merchandise are well known but are generally pre-fabricated and are either constructed on site in a fixed format, or are purchased from suppliers in pre-designed formats that may not exactly suit the particular requirements of a user. Individual display panels are not generally designed or available to be combined to form a purpose-built, conformable, unified display structure.

Embodiments of the invention aim to give the user the freedom and flexibility to design a display system or similar panel design structure employing the use of panels that can be inter-engaged to suit the user's particular requirements in a variety of formats and to self-assemble the same. Display panels can be added, changed, or replaced as part of a self-assembly display system.

One embodiment described herein relates to a single panel, ideally manufactured from plastics or other resistant materials, that combines along the length one of its vertical sides, a male coupling and along the length of the opposite vertical edge, a female coupling. Multiple panels can then be snap-fitted together along their vertical edges to form a continuous interlocking hinged joint between them. The hinged joint can be rotated within a range without dislocation or disengagement. The range of rotation allows panels to be inter-engaged in a variety of flat and three-dimensional structures.

The panels incorporate additional interlocking male and female connectors on their horizontal edges. These connectors enable panels to be locked together in a vertical position or enable them to be attached to supports from their horizontal edges.

By combining hinged connectors that interlock on the panel's vertical axes with locking connectors on their horizontal axes, multiple panels can be joined and displayed in a variety of multi-dimensional formats to suit the requirements of the user. Additionally, the vertical and horizontal panel connectors can be made to function as shielded electrical circuits for lighting purposes or for the addition of electrical and electronic accessories.

Each panel embodies various fitting channels or mounting positions that enable the panels to accommodate a variety of presentation attachments, such as leaflet dispensers, card holders, merchandise accessories, pictures, frames, electrical and electronic fittings or other decorative attachments.

Panels further embody connection housings to attach support structures. For example to attach a panel or a display to a flat surface such as a wall, to support a free standing panel or a display structure in a fixed or mobile position, to lock panels into a fixed position on a platform e.g. by applying a locking rod through the housings of one or more connecting panels, and to enable a panel or a display structure to be suspended.

Embodiments of the panels can be coupled to other similar panels using interlocking panel couplings to self-assemble multi-panel display structures for a variety of purposes. When used to display literature and merchandise, the panel acts as a mounting frame to which a variety of mountable fixings can be attached, including attachments to hold leaflets, cards, notices, pictures, merchandise, accessories, electrical and electronic fittings. The display panel has applications for lighting and decorative designs as well as picture framing.

The panels may combine an interlocking hinge coupling on their vertical edges, that forms a continuous, rotatable connection along two adjacent panel vertical edges. Interlocking connectors on two adjacent panel horizontal edges enable panels to be locked together vertically. This connectivity enables a person to design and self-assemble multi-dimensional display structures from the panels. Modern materials particularly metals and plastics, in the form of easily self-assembled panels provide the ideal building medium for creative contemporary display and decorative designs.

According to a first aspect of the present invention there is provided a display panel having first and second opposing edges, the first edge comprising a male part of a hinged connection and the second edge comprising a counterpart female part.

According to a second aspect of the invention, there is provided a display panel, comprising a panel having first and second sides being disposed substantially opposite one another, and wherein a male part of a continuous interlocking hinged connection is disposed on the first substantially thereof and a female part of a further continuous interlocking hinged connection is disposed on the second side thereof. An advantage of the connection is that a panel can be attached to a similar panel in a variety of configurations.

The male part may be generally C-shaped with an engaging portion protruding from a mid-point thereof. The female part may be generally C-shaped with a receiving portion protruding from a rear section thereof. This allows the interlocking connection to be smoothly and continuously hingeable yet securable. The male part and the female part of the continuous interlocking hinged connection may extend rearwardly with respect to a front face of the panel. This enables the connection to be hidden behind the panel in any configuration, creating an aesthetically appealing display.

The male part of the continuous interlocking hinged connection may be arranged to be interlockable with a female part of the connection disposed on a substantially vertical side of a further panel according to the first or second aspects of the invention. The panels are thus securely connected but able to move relative to each other.

The panel and the further panel may be arranged to be rotatable relative to each other through a range of rotation. The panels can be therefore be easily arranged at the desired orientation.

The range of rotation may be between at least a first connection position in which an angle between the panel and the further panel is an acute angle and at least a second connection position in which the angle between the panel and the further panel is 180°. This allows the panels to be arranged adjacent to each other in a straight line or at any angle between a straight line (180°) and an acute angle, enabling great flexibility to the configuration of the display. The acute angle may be approximately 60°. This allows three such panels to be formed as a display structure having a triangular platform.

The male part of the connection and the female part of the connection may be arranged to be lockable in position with a lock in at least one connection position thereof. This feature improves the security of two panels, ensuring they will not become disassembled without appropriate force being applied thereon. The lock may be a snap fit. The connection is therefore easy to assemble by hand. The connection position the angle between the panel and the first panel may be 60°.

The male part of the connection and the female part of the connection may be formed integrally with the panel. This enables ease and speed of assembly.

The display panel may include a front face, the front face including at least one fitting for the mounting of a presentation attachment. A single fitting can thus house various types of presentation attachment such as a literature pocket or poster. The presentation attachment may be an electrical or electronic fitting. Such a fitting may include a light fitting, a computer screen or other digital display.

The display panel may include a rear face, which may include at least one connection housing for the attachment of a support structure.

The connection housing may be a conduit for the housing of an electrical wire. The panel may also comprise a substantially horizontal side. The support structure may be a connector for the attachment of two panels at the horizontal edge thereof.

Exemplary embodiments of the invention will now be described with reference to the accompanying drawings, in which:

FIG. 1 shows a cross-section through a display panel embodying the invention;

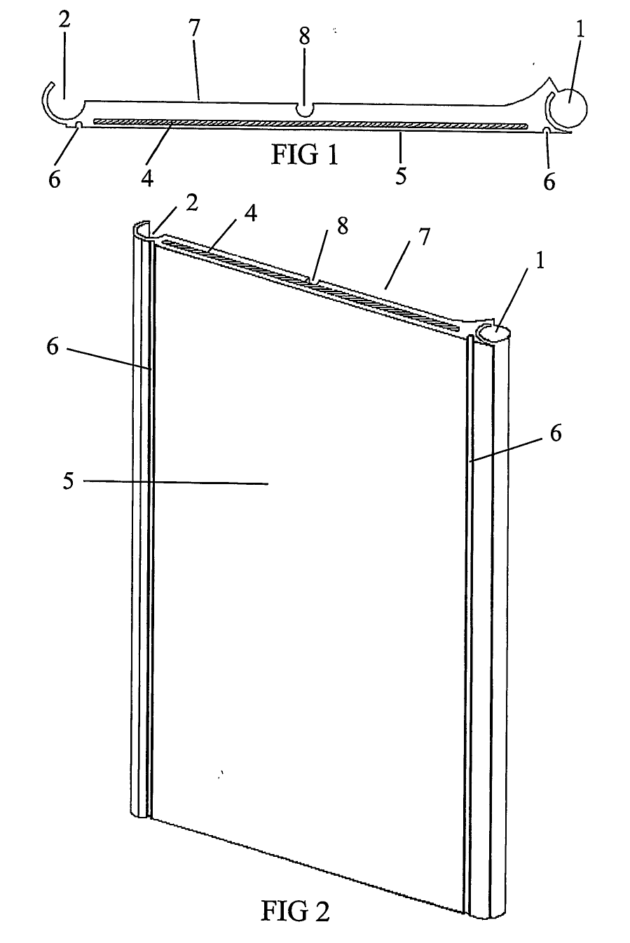

FIG. 2 shows a perspective view of the display panel of FIG. 1;

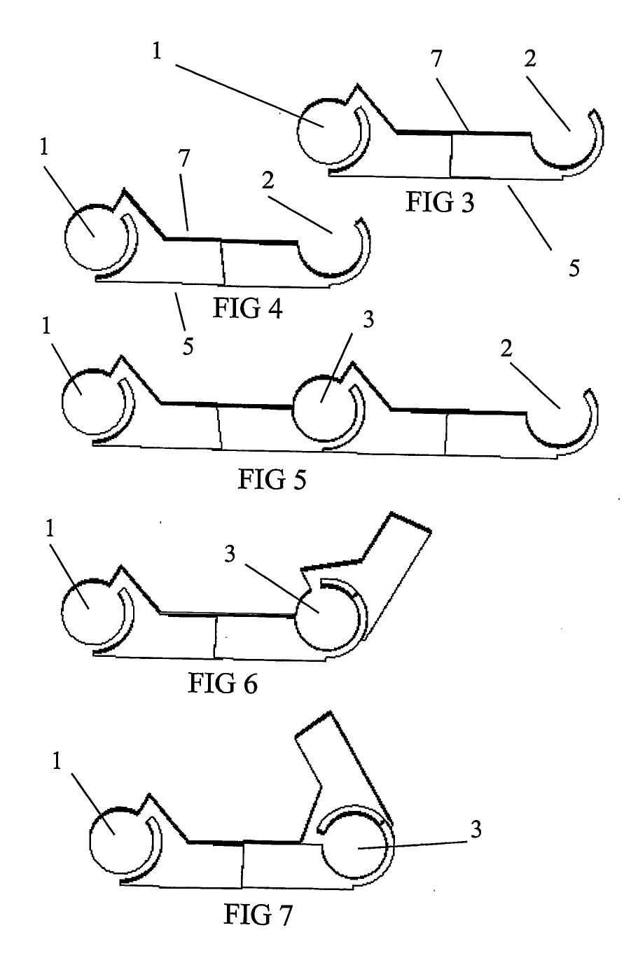

FIGS. 3 and 4 show partial cross-sections of two panels prior to being connected together;

FIG. 5 shows a partial cross-section of two panels connected together and disposed in a straight line;

FIG. 6 shows a partial cross-section of two panels connected together and mutually disposed at 120°;

FIG. 7 shows a partial cross-section of two panels connected together and disposed at 60°;

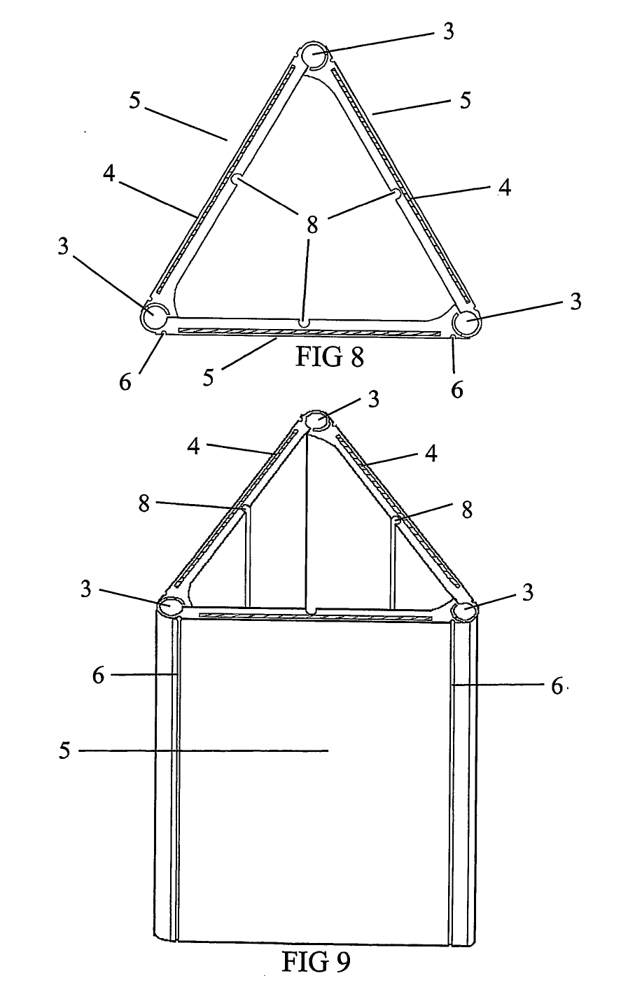

FIG. 8 shows a cross-section of three panels connected together to form a triangular shape;

FIG. 9 shows an elevation of the panels of FIG. 8;

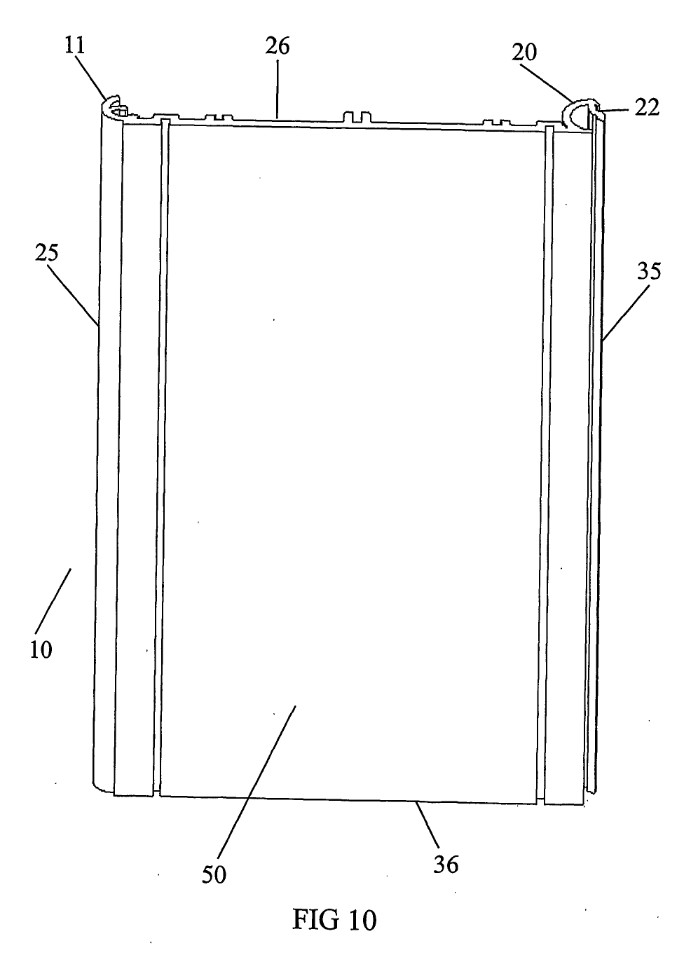

FIG. 10 shows a front elevation of a second display panel embodying the invention;

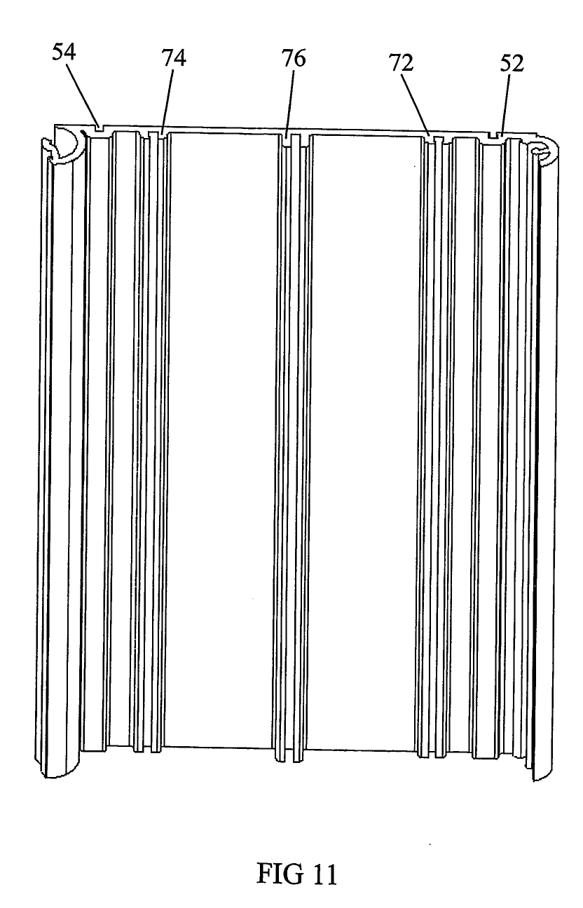

FIG. 11 shows a rear elevation of the display panel of FIG. 10 showing an embodiment of the central rear channel;

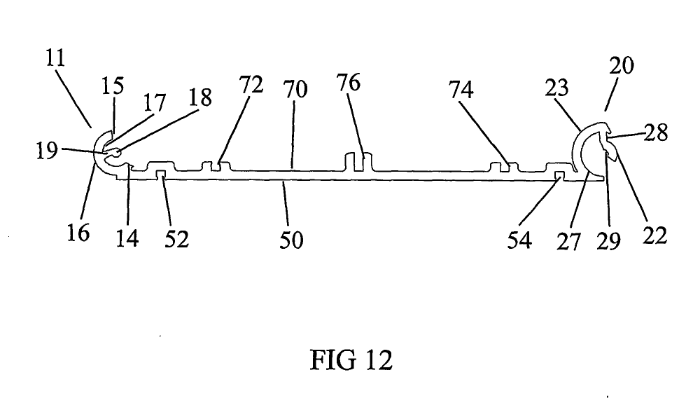

FIG. 12 shows an end view of the display panel of FIG. 10;

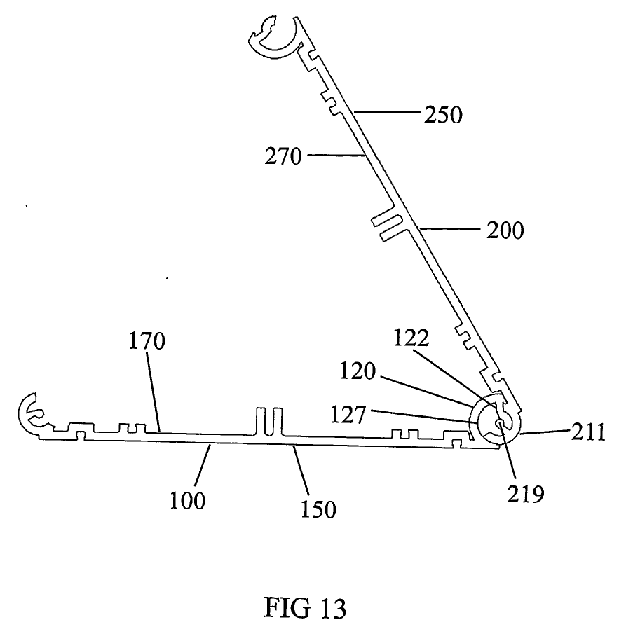

FIG. 13 shows an end view of an assembly of two of the second display panels of FIG. 10 connected together and mutually disposed at 60°;

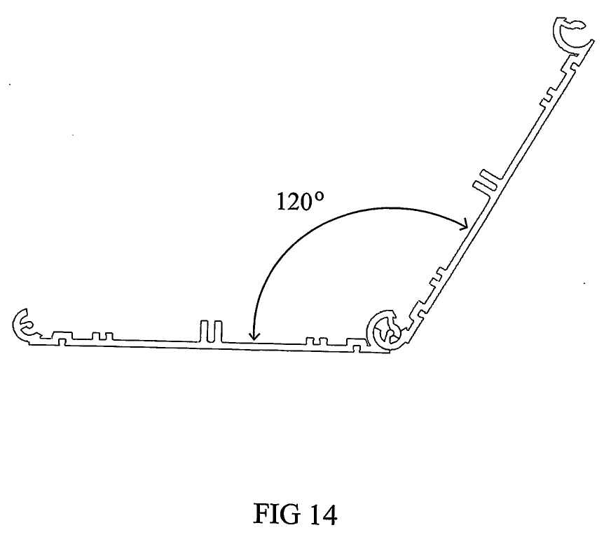

FIG. 14 shows an end view of an assembly of two of the second display panels of FIG. 10 connected together and mutually disposed at 120°;

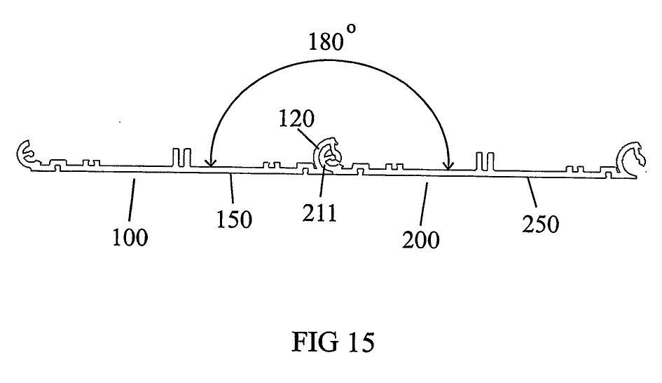

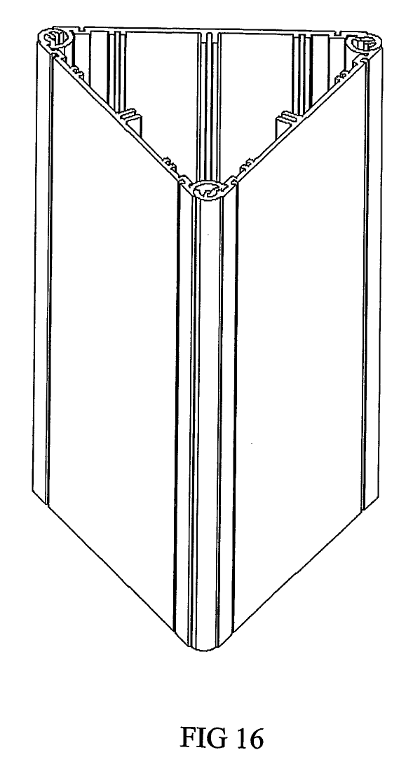

FIG. 15 shows an end view of an assembly of two of the second display panels of FIG. 10 connected together and mutually disposed at 180°;

FIG. 16 shows a perspective view of an assembly of three of the second display panels of FIG. 10 connected together to form a triangular body;

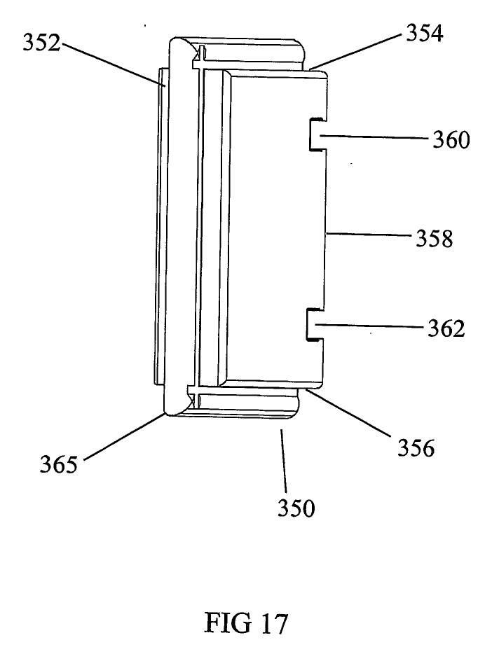

FIG. 17 shows a perspective view of a multi-purpose connect piece;

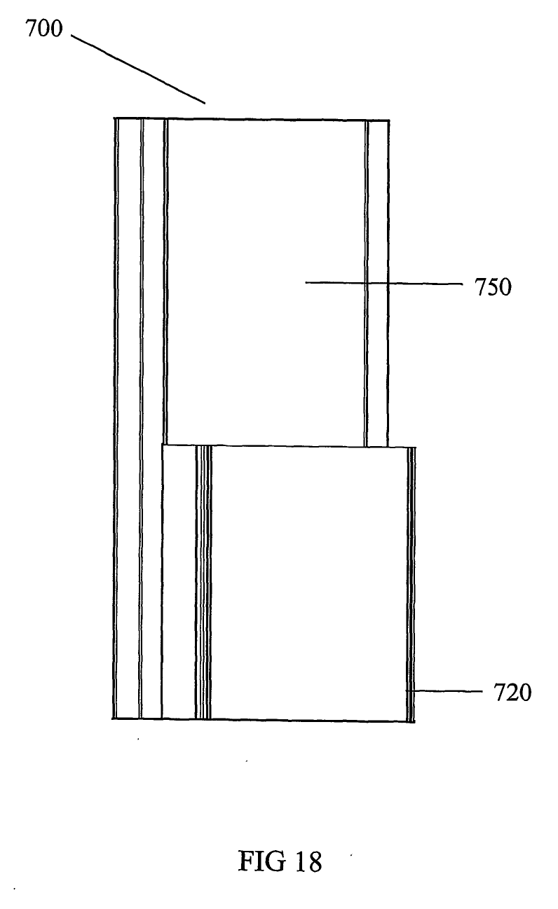

FIG. 18 shows an assembly of a panel embodying the invention and a literature pocket;

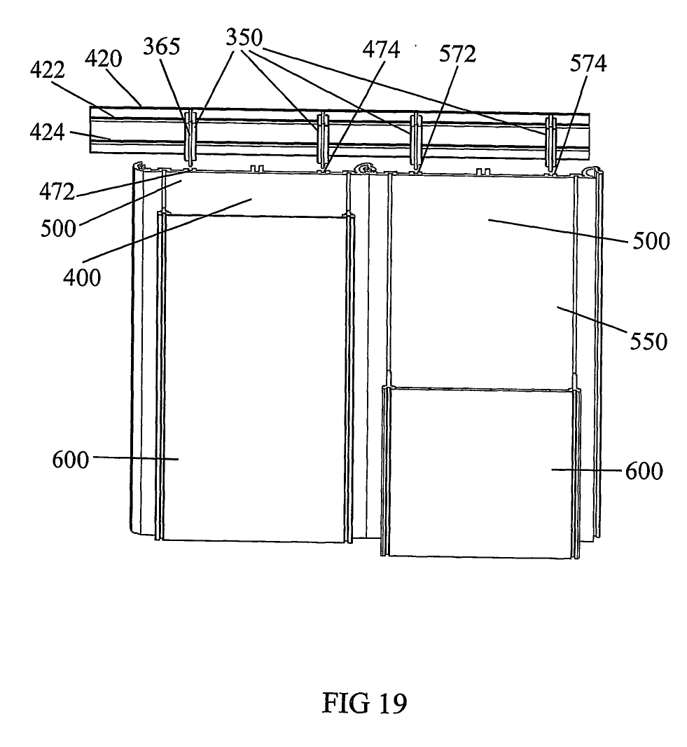

FIG. 19 shows a perspective view of an assembly of two second display panels of FIG. 10 mounted via the multi-purpose connect piece of FIG. 17 to a wall mounting rail;

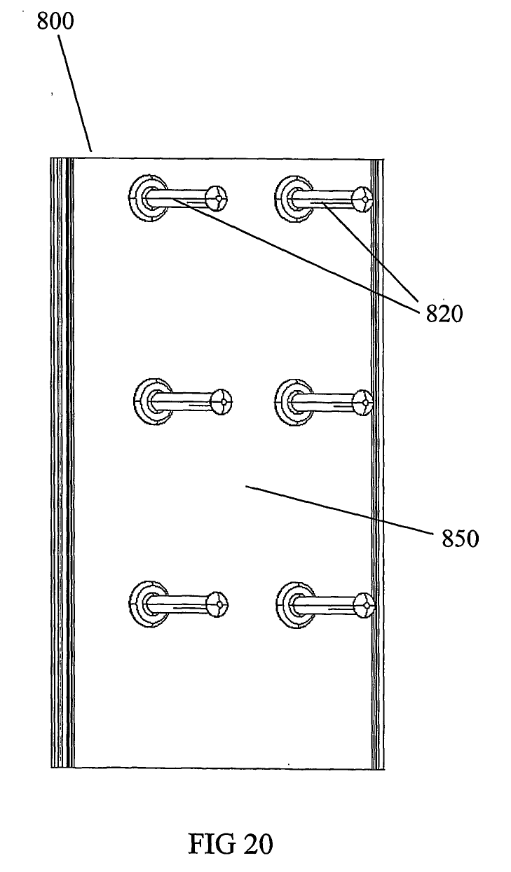

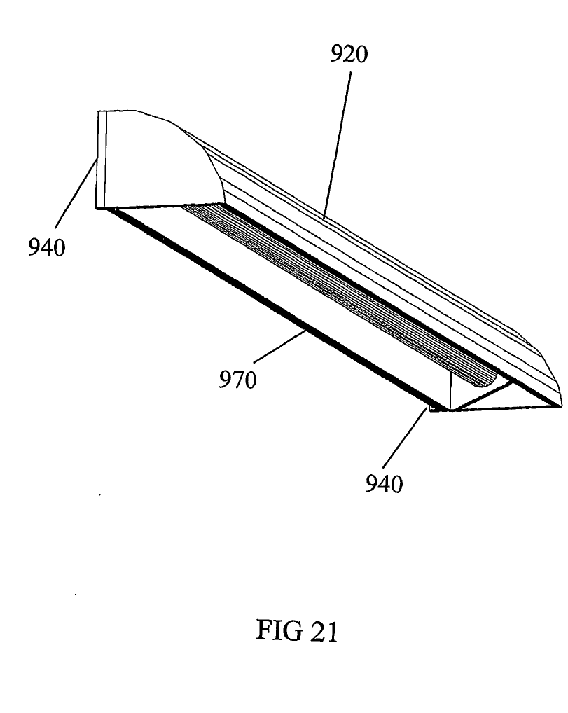

FIG. 20 shows a display panel similar to the panel of FIG. 10 and having a merchandise attachment;

FIG. 21 shows a light fitting attachment for use with a display panel embodying the invention;

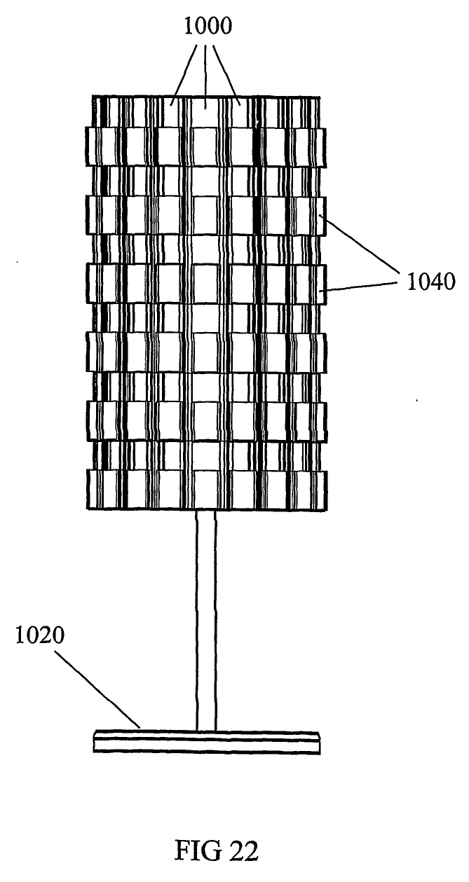

FIG. 22 shows a partial perspective view of a floor standing literature carrousel, having 120 display panels of the invention inter-engaged vertically and horizontally, and fitted to a base;

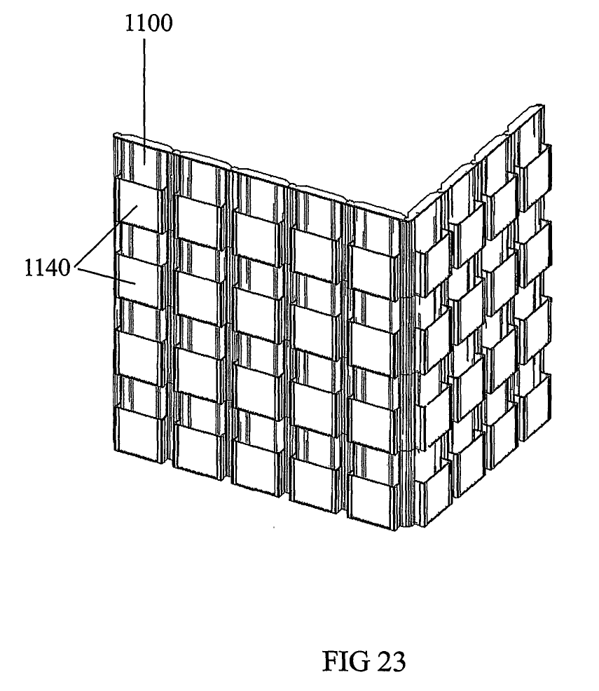

FIG. 23 shows 36 display panels inter-engaged both vertically and horizontally to form a literature display;

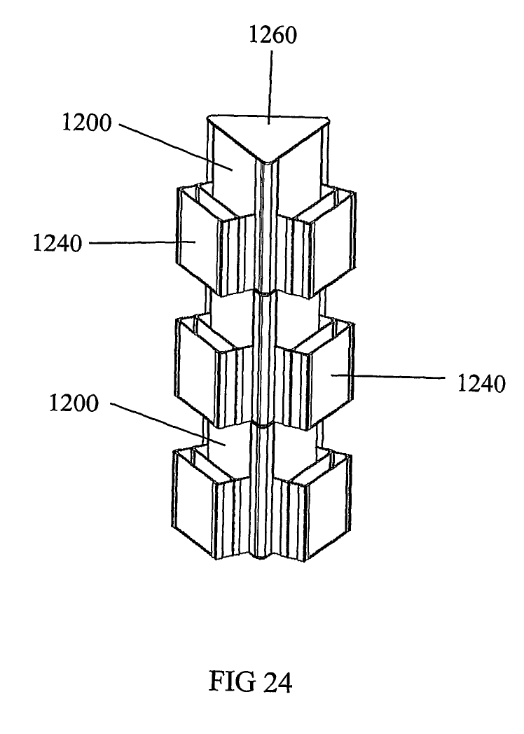

FIG. 24 shows 9 display panels inter-engaged to form a three tier double pocket triangular display system;

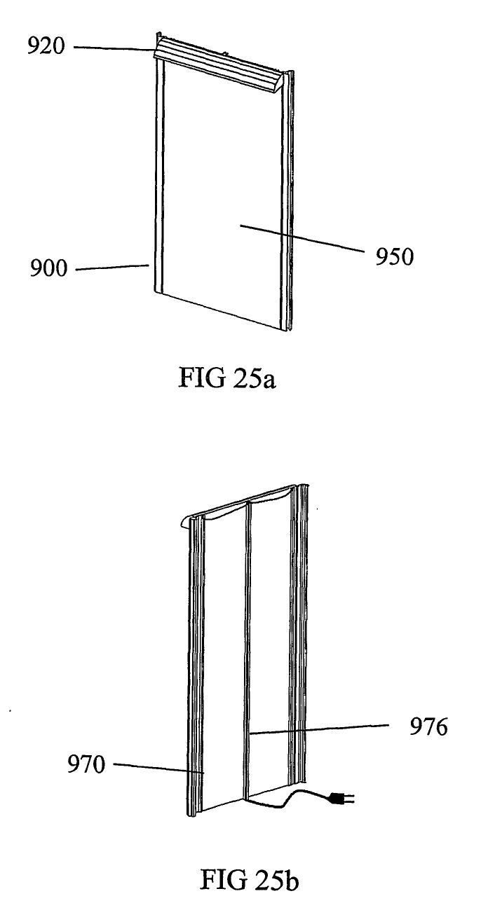

FIG. 25a shows a schematic of a display panel of the invention showing an electrical light fitting attached to a front face thereof;

FIG. 25b shows a schematic of a display panel of the invention showing a rear connection housing in use as a conduit for an electrical wire of the electrical light fitting;

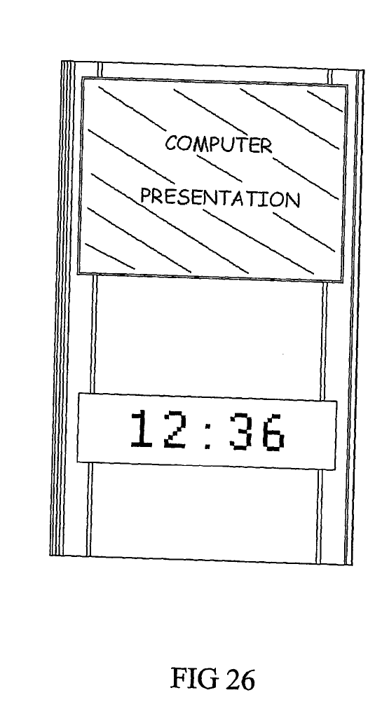

FIG. 26 shows a schematic of a display panel of the invention having a digital display and screen;

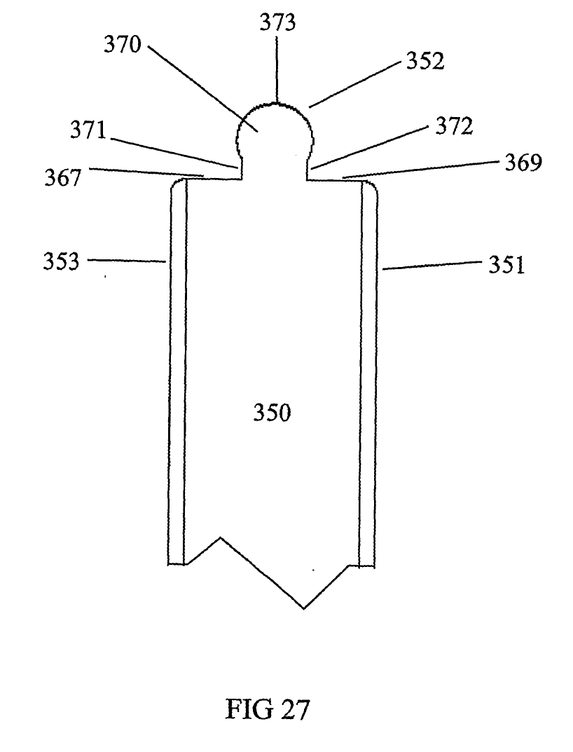

FIG. 27 shows detail of the connecting piece of FIG. 17;

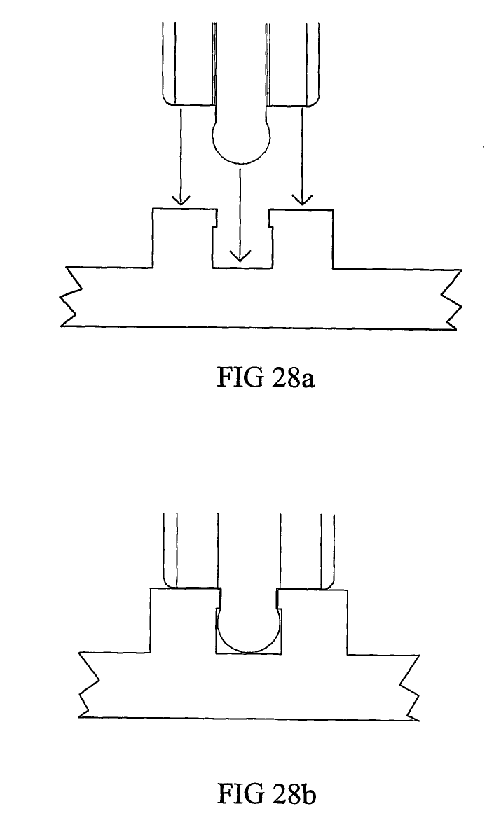

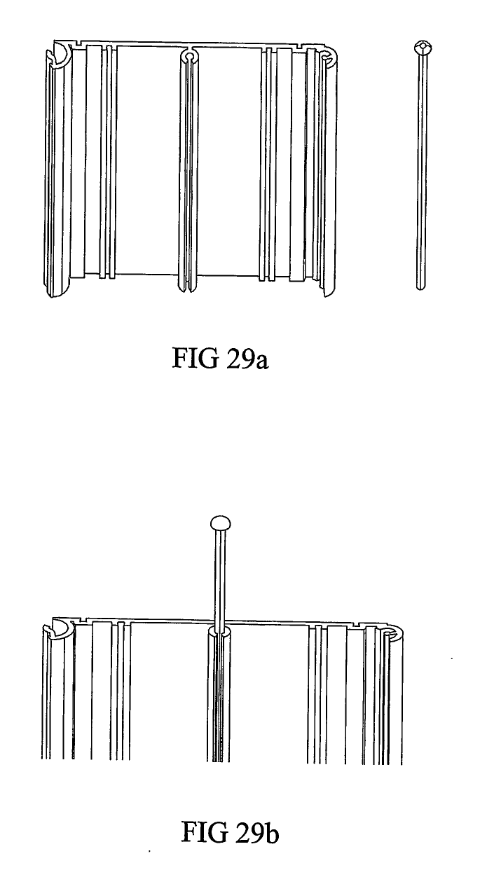

FIG. 28a shows schematically how an attachment is fastened to a display panel of the invention;

FIG. 28b shows a schematic of an attachment fastened to a display panel of the invention;

FIG. 29a is a schematic of a display panel of the invention showing an alternative embodiment of a central rear channel and showing a locking rod; and

FIG. 29b shows schematically how the locking rod of FIG. 28a fastens into the central rear channel of a display panel according to the invention

Referring to FIGS. 1 and 2, a display panel 5 can be used as a mounting frame for a variety of mountable attachments. The panel 5 is generally planar and rectangular, and has a planar front face and a rear face 7. The panel 5 has along its respective vertical edges, a male coupling on one edge, 1 and a counterpart female coupling on the opposite edge, 2. When connected with a matching panel edge, FIG. 3 and FIG. 4, the couplings snap-fit together to form a continuous, interlocking, vertical, hinged connection between the adjoining panels, 3. The male and female couplings are positioned to snap together at about their minimum adjoining angle, FIG. 7 and can be rotated to numerous other angles, FIGS. 5 and 6. The male and female couplings are interconnected, 3 throughout their rotation and this prevents adjoining panels from dislocating or disengaging. This hinged connection enables multiple panels to be joined together into numerous multi-panel structural formats, including triangular, FIG. 8 and FIG. 9 and multi-faceted bodies as well as flat and other three dimensional panel formats.

The display panel 5 has slots 6 forming mounting connectors, that can be used to mount a variety of attachments to the panel such as logos, leaflet dispensers, card holders, merchandise holders, hooks for accessories, pictures and frames, lighting, and electronic fittings. In the embodiment of FIGS. 1 and 2, the slots 6 run parallel to the edges 1,2 and to the ends, but other locations may be used where appropriate.

The back face 7 of the display panel defines one or more recesses 8 to accommodate support structures. These are shaped as desired to attach panels to a flat structure such as a wall, to support free-standing panels in a fixed or mobile position, or to enable panels to be suspended and/or to insert a locking rod or other device for the prevention of unauthorised removal of panels or for securing panels to a platform.

Display panels embodying the invention may be manufactured to suit a number of panel system sizes or size combinations. They may readily be self-assembled.

Individual display panels and their moulded interlockable couplings may be constructed as one-piece units from plastics by extrusion or injection moulding. An alternative is to use a metal, such as aluminium, which can be extruded. It is also envisaged that display panels embodying the invention and the interlocking couplings be manufactured separately, with securing by bonding or other means of attachment later as a separate process.

Display panels may be produced in a variety of sizes, styles, colours, transparencies, textures and shapes to suit a wide range of display structures and can be overprinted for a variety of purposes.

Referring to FIG. 10, a display panel 10 is a generally rectangular panel having first and second mutually parallel vertical edges 22, 35, first and second mutually parallel ends 26, 36, a front face 50 and a rear face 70, shown in FIG. 12. It is noted that the terms vertical and horizontal, and front and rear, are used for clarity of description in describing this embodiment and that the invention is not limited to a panel of this orientation. The edges 22, 35 form a releasable coupling allowing hinging between adjacent panels, while securing the panels together.

Integrally formed along first edge 22 is the male part 11 of the releasable coupling. The male part is best seen in FIG. 10 and FIG. 12 and is a generally semi-circular C-portion 11 extending laterally and rearwardly from the panel such that an external convex face 16 of the C-portion forms a rearwardly curving extension of the front face 50 of the panel 10. The C-portion 11 has a proximal end face 14 and a distal end face 15. The C-portion 11 is set slightly back from the front face 50 so that there is a step transition between the front face 50 and the curve of the male part 11. The proximal end face 14 of the C-portion 11 lies adjacent the rear face 70 of the panel, is disposed rearwardly from rear face 70 to form a step transition between the end face 14 and the rear face 70. As will be understood by reference to FIG. 12, the size of this step is such as to correspond to a thickness of a tapering end part of an adjoining panel so that two panels can together form a substantially continuous sheet. The C-portion 11 further has a concave internal face 17 and a second end face 15 at the rearmost portion of the C-portion. Protruding from the centre of the rear face 17 is an engaging portion 19, extending radially to the centre of the semicircle defined by the C-shaped portion 11. The engaging portion 19 is a fillet piece extending from the concave internal face 17 to an end having a substantially circular formation 18 around the centre of the semicircle. This provides for engagement of the female part when in use.

The second edge 35 of the panel 10 has an integrally-formed female part 20 of the releasable coupling. The female part 20 is best seen in FIG. 10 and FIG. 12, and also comprises a generally C-shaped semi-circular portion, having a distal end and a proximal end. The female part 20 has a convex external face 23 and a concave internal face 27. The internal face 27 is exposed along the 35 edge of the panel 10 to the side of the panel 10. The external face 23 is directed substantially laterally inwardly of the panel towards a centre line of the panel 10. The radius of the internal face 27 from the centre of the semi-circular female part is slightly larger than is the radius of the external face 15 of the male part 11 such that in use, the external face 15 of the male part is able to fit snugly inside the internal face 27 of the female part. Protruding forwardly from a position close to the distal end of the C-shaped circular portion is a second fillet member 22 forming a receiving portion 22. The second fillet member 22 extends from the internal face 27 via a radial straight portion 28 to a hooked end portion 29. The hooked end portion 29 defines a concavity around the centre of the semicircle defined by the C-shaped part 20.

The circumferential extent of the male part is such that when a male part is inter-engaged with a female part, the distal end 15 of the male part abuts the second fillet member 22. The overall dimensions of the male and female parts allow the male part 11 to fit closely inside the female part 20 of an adjoining panel when the male and female parts are inter-engaged.

The front face 50 of the panel 10 defines first and second channels 52, 54 running vertically therealong spaced from a centre line of the panel 10. First channel 52 runs generally parallel to and adjacent to the male part 11 and second channel 54 running generally parallel to and adjacent to the female part 20. The channels 52, 54 form the groove part of a tongue and groove fastening mechanism for the attachment of various presentation attachments in use.

As seen in FIG. 11 and FIG. 12, first to third pairs of longitudinal projections 72, 74 and 76 protrude from the rear face 70 of the panel 10 to define channels. The third pair 76 of longitudinal projections are disposed on each side of the centre line of the panel 10. First and second pairs of projections 72 and 74 are spaced apart symmetrically on each side of the centre line but closer to the centre line than the front-face channels 52, 54. The third pair 76 of longitudinal projections protrude further from the rear face of the panel 10 than the first and second pairs of projections 72 and 74, thereby to define a relatively deeper channel. The size and shape of the channel defined by the third pair 76 of projections permits accommodation of electrical wiring therein for electric presentation attachments if so desired and/or for use as a locking device e.g. by inserting a locking rod through one or more vertically connected panels. In practice, any of the channels or projections can be appropriately configured to permit accommodation of electrical wiring and/or a locking device.

FIG. 13 shows two panels 100, 200 each generally identical to the panel 10. The male part 211 of panel 200 is inter-engaged with the female part 120 of panel 100. The male part 211 and female part 120 form a rotational hinge which is continuous along the edges of the panels. Further reference to FIG. 13 shows that the panels 100 and 200 are disposed at substantially 60°, the minimum angle between the rear face 170 and rear face 270 of each respective panel 100, 200. Substantial further movement of the panels toward one another would cause disengagememt.

In this orientation the male part 211 sits partially inside the female part 120 and the substantially circular formation 219 of panel 200 is engaged by the hooked end portion 122 of the panel 100. The male part 211 fits partially and snugly adjacent the inner face 127 of the female part 120. Thus, the panels are removably inter-engaged with each other, yet the male part of the connection is able to rotate inside the female part of the connection to change the included angle between the rear faces of the panels within a range of this minimum angle of 60°, up to and including 180° (shown in FIG. 15). In FIG. 14 the two panels are shown inter-engaged at an angle of approximately 120°. At 180°, the male part 211 is entirely enclosed in the female part 120 and the front faces 150 and 250 of the panels 100 and 200 lie flush with one another to form a seamless enlarged panel. Several panels may be connected together at the vertical edges thereof to produce different sizes of display panel as required. For example, FIG. 16 shows three such panels inter-engaged together and an included angle of 60° between the rear face of each panel to form a sturdy triangular shaped display system. As a further example, five such panels could be inter-engaged together with an included angle of 108° between two panels, to form a pentangle shaped system.

In order to produce further configurations of the display system, a multi-purpose connector 350 is provided. Shown in perspective view in FIG. 17, the connector 350 is a plastic or metallic block-shaped body. The body has opposed generally rectangular first and second major faces 351, 353, first and second opposed long side faces 352, 358 and first and second short side faces 354, 356.

The first long side face 352 and the first and second short side faces 354, 356 each have a similar form. The form of one of these side faces will now be described with reference to FIG. 27.

Referring to FIG. 27, the two major faces 351, 353 of the connecting piece 350 extend via respective shoulder portions 367, 369 into a central projecting portion 370. The central projecting portion 370 has first and second opposing generally planar side faces 371, 372 and a distal curved end face 373 extending between the side faces 371, 372. The side faces 371, 372 and the distal curved end face 373 form a rounded tongue 365 that is shaped to fit into the channels 52, 54 and the channels between the projection 72 and 74 of the panel 10, 100 or 200. Thus the connector can be attached to the panel along its short sides 354, 356 or its long side 352. The second long side face is substantially planar but defines first and second channels 360, 362 each running laterally across the second long side face 358. The channels 360, 362 are of equal size and are symmetrically arranged about a median plane line between the first and second short side. The first channel 360 lies toward the first short side face 354 and the second channel 362 lies toward the second short side face 356. In use, these channels 360, 362 provide groove parts of tongue and groove attachment mechanisms such as shown in FIG. 19.

FIG. 19 illustrates one use of the connector 350. Two panels 400, 500 are inter-engaged together at 180°. The panels 400, 500 are hung vertically from a wall mounted rail 420 that includes horizontal tongues 422 and 424. Several connectors 350 are shown attached to the wall-mounted rail 420 via the tongue and groove mechanism of the tongue 422 and 424 and the grooves 360, 362 of the bottom face 358 of the connector 350. The connection between the connectors 350 and the panels 400 and 500 is exploded in FIG. 19 for clarity. In use, the tongue 365 of the connector 350 is inserted into one of the channels 472, 474, 572 or 574 of the panels 400 and 500 respectively. When assembled, the panels 400 and 500 completely obscure the wall-mounting rail 420, providing an aesthetic wall mounted display system.

It is envisaged that a connector 350 can be used to connect two panels together in a vertical direction at the ends thereof. In order to attach two panels in this way, one half of the connector 350 is inserted into the channel formed between the longitudinal projections 72 or 74 of one panel whilst the other half of the connector is inserted into the corresponding channel of the second panel. Thus, the display system may be extended in the vertical direction as well as in the horizontal direction.

It is further envisaged that the connector 350 can be used to add stability to the rear faces of panels forming a polygon stand where necessary.

Various presentation arrangements and fittings may be fitted to the panel, some of which are illustrated in FIGS. 19, 20, 21 and 22. In FIG. 19, display hangings 600 are attached to the front face 450 and 550 of the panels 400 and 500 respectively, using the tongue and groove attachment mechanism described earlier. Tongues (not shown) are provided at the rear of the display hanging for attachment to the panel. FIG. 18 shows a panel 700 with a literature pocket 720 attached to the front face 750 thereof. FIG. 20 shows a display panel 800 with pegs 820 attached to the front face 850 thereof for the display of various merchandise. FIG. 21 shows a light fitting attachment 920 for use with a display panel (not shown). The light fitting attachment 920 is approximately the width of a panel and is attached to the panel using tongue portion 940 at a rear face 970 thereof. The light fitting 920 is shown schematically attached to a panel 900 in FIG. 25a. In this particular embodiment, the light fitting is attached at the top of the panel. FIG. 25b shows a rear view of the panel 900 and illustrates how the electrical wiring of an electrical fitting such as the light fitting 920 can be discreetly housed in the channel 976 running down the centre of the panel 900. Other forms of presentation attachments envisaged include electronic displays, screens such as those illustrated schematically in FIG. 26.

FIGS. 22, 23 and 24 show specific examples of how several panels can be inter-engaged together both vertically and horizontally to produce different types of display system. In FIG. 22, 120 panels 1000 are shown inter-engaged together as 6 levels of 20 panels, the bottom level of which is mounted upon a floor standing base 1020 to form a floor standing literature carousel. Each panel 1000 has a literature pocket 1040 attached thereto for presentation of various literature. In FIG. 23, 36 such panels 1100 are shown inter-engaged together vertically and horizontally in two blocks of 20 panels and 16 panels respectively, the two blocks hinged together at 90° to form an angular wall mounted literature display. Each panel has a literature pocket 1140 attached thereto for the display of various literature. Such a display system could be floor mounted or mounted on a wall mounted railing as described previously. FIG. 24 shows a three tier double pocket triangular display system in which 9 panels 1200 are inter-engaged together as a triangle over three levels. The display system is provided with a lid 1260 that snap-fits into position on top of the triangular structure to improve the aesthetics of the display system. A base may also be provided (not shown). Double pocket literature pockets 1240 are provided for the display of various literature. It is envisaged that the invention can be manufactured from plastics or metal or wood or a combination thereof. In particular, where the panel is manufactured from plastics or metal, the panel is extruded as a single piece, with the male and female interlocking parts formed integrally with the panel. Whilst this is advantageous, it is not necessary that the male and female parts are formed integrally with the panel and may be secured to the panel afterwards. It is further envisaged that the panels may be of various colours and appearances including metallic, transparent or opaque colour in order to provide a variety of finishes according to requirements and application of use.

The male and female parts of the panel need not be along the vertical side there of and equally be along the horizontal sides thereof. Furthermore the sides of the panel need not be parallel if such a display configuration required otherwise. Indeed, the sides need not be vertical and horizontal but could be angled to the vertical and/or to the horizontal.

1-26. (canceled)

27. A display panel having first and second edges, the first and second edges being mutually opposing, the first edge comprising a male part of a hinged connection and the second edge comprising a female part, the female part being counterpart to the male part, wherein the male part has a generally semi-circular outer wall and has a member extending generally radially inwardly of the semi-circular outer wall.

28. The display panel of claim 27, wherein the male part and the female part run continuously along the respective edges of the display panel.

29. The display panel of claim 27, wherein the semi-circular outer wall of the male part has an outer part-circular-cylindrical surface and the female part defines an opening having a wall for engagement by said surface.

30. The display panel of claim 27, wherein the female part comprises a proximal portion and a proximal portion, the proximal portion extending from a planar portion of said display panel to the distal portion, and further comprises a generally radial member with a hooked end portion extending from the distal portion.

31. The display panel of claim 27, wherein the display panel has a front face and an opposing rear face, and the male and female parts extend rearwardly with respect to the front face.

32. The display panel of claim 27, wherein the panel is configured to allow a further said panel engaged therewith by the hinged connection to be rotatable relative to each other through a range of rotation.

33. The display panel of claim 32, in which the range of rotation is between at least a first inter-engaged position in which an angle between the panel and the further panel is an acute angle and at least a second inter-engaged position in which the angle between the panel and the further panel is at least 180 degrees.

34. The display panel of claim 33, in which the said acute angle is approximately 60 degrees.

35. The display panel of claim 27, wherein the male part of the display panel and the counterpart female part of a further display panel form a releasable fastening.

36. The display panel of claim 35, in which the male part of the connection and the female part of the connection are removably securable via a snap fit.

37. The display panel of claim 27, wherein the panel is configured to allow a further said panel engaged therewith by the hinged connection to be rotatable relative to each other through a range of rotation between at least a first inter-engaged position in which an angle between the panel and the further panel is an acute angle and at least a second inter-engaged position, wherein rotation to an angle less than said acute angle allows connection via the hinge connection to be released.

38. The display panel of claim 27, in which the male part and the female part are integral with the display panel.

39. A display panel having first and second opposing edges, the first edge comprising a male part of a hinged connection and the second edge comprising a counterpart female part, the display panel having a front face, the front face including at least one fitting for the mounting of a presentation attachment.

40. The display panel of claim 39, in which the presentation attachment is an electrical or electronic fitting.

41. The display panel of claim 39, in which the presentation attachment is a merchandise or literature fitting or picture fitting.

42. The display panel of claim 39, in which the presentation attachment includes a frame or border fitting.

43. A display panel having first and second opposing edges, the first edge comprising a male part of a hinged connection and the second edge comprising a counterpart female part, the panel having a rear face, the rear face including at least one formation for the attachment of a support structure.

44. The display panel of claim 43, in which the at least one formation includes a conduit for the housing of an electrical wire.

45. The display panel of claim 43, in which the at least one formation includes a conduit for the insertion of a rod or device for securing the panel in place.

46. The display panel of claim 43, in which the panel comprises opposed ends, and has an electrical conductor running between the opposed ends, wherein an electrical connection is provided at said ends to enable current to flow through panels engaged at their ends.

47. A display panel having first and second opposing edges, the first edge comprising a male part of a hinged connection and the second edge comprising a counterpart female part, the panel being formed as a single piece extrusion.

48. A connector for connecting a first display panel having first and second opposing edges, the first edge comprising a male part of a hinged connection and the second edge comprising a counterpart female part, said display panel having an end to another display panel having first and second opposing edges, the first edge comprising a male part of a hinged connection and the second edge comprising a counterpart female part, said connector being adapted to connect said display panels at their ends.

49. A display system having plural rectangular display panels, each having opposing faces, first and second opposing long edges and first and second short edges wherein each panel is configured to be hingedly and releasably connectable to a respective other panel along its long edges and to be releasably connectable to a respective other panel at its short edges.

50. The display system of claim 49, wherein each panel is arranged to support an electrical conductor, and further comprising respective connectors for connecting between the conductors of respective panels.
